(19) United States
(12) Patent Application Publication
(10) Pub. No.: US 2023/0016089 A1
(43) Pub. Date: Jan. 19, 2023

(54) IMPEDANCE HEATED CONTINUOUS EMISSION MONITORING SYSTEM

(71) Applicant: INDEECO, LLC, St. Louis, MO (US)

(72) Inventor: JOHN G. KOZICH, CYPRESS, TX (US)

(21) Appl. No.: 17/864,692

(22) Filed: Jul. 14, 2022

Related U.S. Application Data
(60) Provisional application No. 63/222,830, filed on Jul. 16, 2021.

(51) Int. Cl. F27B 9/04; F27B 9/06; F27B 9/40

(52) U.S. Cl. CPC F27B 9/045; F27B 9/062; F27B 9/40

(57) ABSTRACT

An impedance heated continuous emission monitoring system has a first terminal of an electric power source connected to an input end of a tube communicating an emissions stack with an emissions analyzer and a second terminal of the electric power source connected to an output end of the tube. An electric current produced by the electric power source flows through the tube and heats the tube by impedance. Heating the tube maintains the temperature of the emissions travelling through the tube from the stack to the emissions analyzer above a dew point temperature of the emissions.

### CROSS-REFERENCE TO RELATED APPLICATIONS

This patent application claims the benefit of the filing date of provisional patent application Ser. No. 63/222,830, which was filed on Jul. 16, 2021.

### STATEMENT REGARDING FEDERALLY SPONSORED RESEARCH OR DEVELOPMENT

Not Applicable.

### BACKGROUND

An emission monitoring system such as a continuous emission monitoring system (CEMS) is a system that monitors gases emitted by a source, such as an industrial source into the environment. A CEMS samples gases or other emissions from the industrial source as the emissions pass through a smokestack or other equivalent type of conduit or passage. More information on CEMS can be found on the website of the United States Environmental Protection Agency at www.epa.gov/emc.

Many industries release large quantities of pollutants through air emissions. A CEMS is often used to monitor industrial process emissions to ensure the industry is in compliance with environmental regulations.

To ensure the proper operation of a CEMS, the industrial emissions monitored are often filtered and/or conditioned to remove matter that could interfere with the proper operation of the CEMS. For example, it is often necessary to keep industrial process air emissions or gas emissions above their dew points to avoid liquids from dropping out of the gas emissions.

However, the process of keeping the monitored industrial gas emissions above their dew point often requires specialized equipment to be added to the CEMS. The specialized equipment is needed to keep the industrial gas emissions above their dew point before the industrial gas emissions are analyzed. The addition of the specialized equipment to the CEMS increases the cost of manufacturing the CEMS, increases the complexity of the CEMS and the complexity of its operation, and introduces sources of potential errors or interference in the proper operation of the CEMS.

What is needed is an inexpensive, straightforward and reliable process of keeping monitored industrial gas emissions above their dew point prior to their being analyzed by a CEMS.

### BRIEF SUMMARY

The impedance heated continuous emission monitoring system (CEMS) of this disclosure provides an economical, reliable, simplified and straightforward means of keeping industrial gas emissions above their dew point prior to the analyzing of the emissions by the CEMS.

The impedance heated CEMS of this disclosure includes an emissions analyzer. The emissions analyzer could be any conventional type of emissions analyzer, for example a gas analyzer.

The impedance heated CEMS includes a tubing system or a tube. The tube has a length that extends between an input end of the tube and an opposite output end of the tube. The input end of the tube is configured for communicating with a smoke stack or other equivalent type of conduit or passage through which gases or other emissions pass. The output end of the tube is configured for communicating with the emissions analyzer.

The impedance heated CEMS also includes a source of electric power. The source of electric power has a first terminal and a second terminal.

A first cable is operatively connected between the first terminal of the source of electric power and the tube. The first cable is connected to either the input end of the tube or the output end of the tube.

A second cable is operatively connected between the second terminal of the source of electric power and the tube. The second cable is connected to the output end of the tube when the first cable is connected to the input end of the tube. The second cable is connected to the input end of the tube when the first cable is connected to the output end of the tube.

Operation of the source of electric power delivers electric power through the first cable to the tube and produces an electric current through the tube from the first cable connected to the tube to the second cable connected to the tube. The electric current passing through the tube generates impedance heating of the tube due to the resistance of the material of the tube to the electric current flowing through the tube from the first cable connected to the tube to the second cable connected to the tube. The resistance to the current flowing through the tube creates impedance heating of the tube that in turn heats the gases or other emissions passing through the tube from the input end of the tube to the output end of the tube.

The heating of the gases or other emissions passing through the tube keeps the gases or other emissions above their dew point prior to the gases or other emissions being communicated with the emissions analyzer at the output end of the tube.

### BRIEF DESCRIPTION OF THE DRAWINGS

FIG. 1 is a schematic representation of the impedance heated continuous emission monitoring system of this disclosure.

FIG. 2 is a flow chart representing the operation of the impedance heated continuous emission monitoring system of this disclosure.

Corresponding reference numerals will be used throughout the several figures of the drawings.

### DETAILED DESCRIPTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what is presently believed to be the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

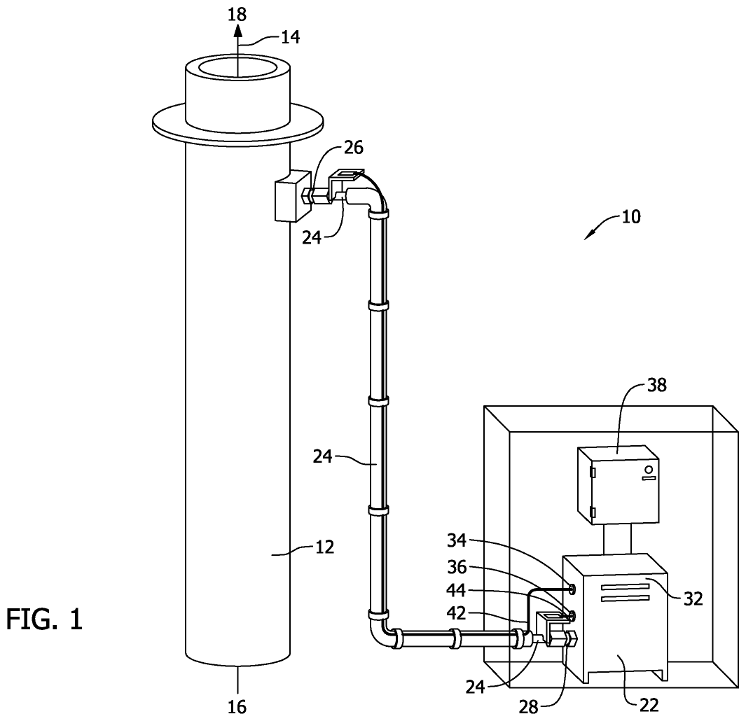

The impedance heated continuous emission monitoring system (CEMS) 10 of this disclosure is represented schematically in FIG. 1. The impedance heated CEMS 10 is represented as being operatively connected to and communicating with a smokestack or stack 12 or other equivalent type of conduit 12. The stack 12 or conduit 12 directs industrial gases or emissions 14 from a source 16 of the emissions to the exterior environment 18.

As represented in FIG. 1, the impedance heated CEMS 10 includes an emissions analyzer 22. The emissions analyzer 22 could be any conventional type of emissions analyzer, for example a gas analyzer.

The impedance heated CEMS 10 includes a tubing system or a tube 24. The tube 24 could be a single tube or could be one tube of a multiple or plurality of tubes arranged in a bundle. The tube 24 is constructed of a material that is a good heat conductor or has good thermal or heat conducting properties. For example, the tube 24 is constructed of a metallic material such as stainless steel. Other equivalent types of materials that are capable of conducting heat can be employed in the construction of the tube 24. As represented in FIG. 1, the tube 24 could be surrounded by an insulating material. The tube 24 has a length that extends between an input end 26 of the tube and an opposite output end 28 of the tube. In the typical construction of the tube 24, the tube 24 has an unobstructed interior bore that extends between the input end 26 of the tube 24 and the opposite output end 28 of the tube 24. The input end 26 of the tube 24 is configured for or has a means for communicating the input end 26 of the tube 24 with the stack 12 or conduit 12 and with the emissions 14 passing through the stack 12. The output end 28 of the tube 24 is configured for or has means for communicating with the emissions analyzer 22.

The impedance heated CEMS 10 also includes a source of electric power 32. The source of electric power 32 is represented in FIG. 1 as being combined with or in the same housing as the emissions analyzer 22. The source of electric power 32 could be an entirely separate unit from the emissions analyzer 22. The source of electric power 32 could be a conventional transformer or any other equivalent source that delivers electric power. The source of electric power 32 has a first terminal 34 and a second terminal 36.

A control panel 38 communicates with the source of electric power 32. The control panel 38 includes manual controls that enable the control of a voltage produced and delivered by the source of electric power 32. The control panel 38 could be any conventional type of control panel. The controls of the control panel 38 could be any type of controls equivalent to manual controls.

A first cable 42 is operatively connected between the first terminal 34 of the source of electric power 32 and the tube 24. For example, the first cable 42 is directly, electrically connected to the first terminal 34 to conduct electricity and electric power to or from the first terminal 34. The first cable 42 is constructed of a material having good electrically conductive properties. For example, the first cable 42 is constructed of copper. The first cable 42 is connected to either the input end 26 of the tube 24 or the output end 28 of the tube 24. As represented in FIG. 1, the first cable 42 is connected to the input end 26 of the tube 24. The first cable 42 is represented in FIG. 1 as being directly, electrically connected to the input end 26 of the tube 24 by an electrically conductive connection of the first cable 42 to the tube 24.

A second cable 44 is operatively connected between the second terminal 36 of the source of electric power 32 and the tube 24. For example, the second cable 44 is directly, electrically connected to the second terminal 36 to conduct electricity and electric power to or from the second terminal 36. The second cable 44 is constructed of a material having good electrically conductive properties. For example, the second cable 44 is constructed of copper. The second cable 44 is electrically connected to the output end 28 of the tube 24 when the first cable 42 is electrically connected to the input end 26 of the tube 24. The second cable 44 is electrically connected to the input end 26 of the tube 24 when the first cable 42 is electrically connected to the output end 28 of the tube 24. As represented in FIG. 1, the second cable 44 is electrically connected to the output end 28 of the tube 24. The second cable 44 is represented in FIG. 1 as being directly, electrically connected to the output end 28 of the tube 24 by an electrically conductive connection of the second cable 44 to the tube 24.

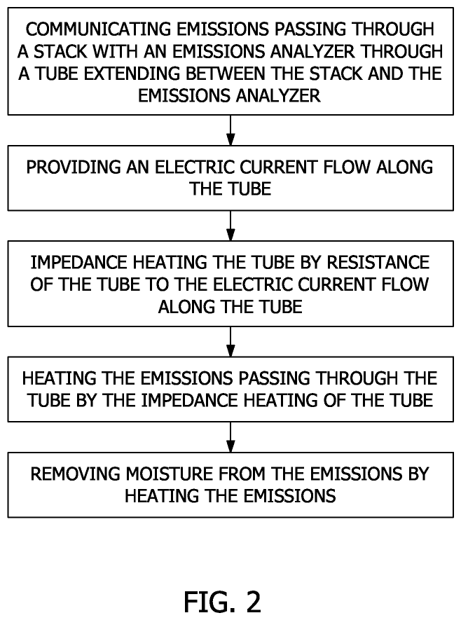

The impedance heating of the CEMS 10 is represented by the flow chart of FIG. 2. Operation of the control panel 38 controls the operation of the source of electric power 32. Operation of a source of electric power 32 delivers electric power through the first cable 42 to the tube 24 and specifically to the input end 26 of the tube 24. The electric power provided to the input end 26 of the tube 24 produces an electric current flow through the tube 24. The electric current flows through the tube 24 from the first cable 42 connected to the input and 26 of the tube 24 to the second cable 44 connected to the output end 28 of the tube 24. The flow of electric current through the tube 24 is resisted by the material of the tube. The resistance of the material of the tube 24 to the electric current flowing through the tube 24 creates impedance heating of the tube 24 due to the resistance of the material of the tube 24 to the electric current flowing through the tube from the first cable 42 to the second cable 44. The impedance heating of the tube 24 in turn heats the gases or other emissions passing through the tube 24 from the input end 26 of the tube 24 to the output end 28 of the tube 24.

The heating of the gases or other emissions passing through the tube 24 keeps the gases or other emissions above their dew point temperature and prevents liquids from separating out from the gases prior to the gases or other emissions being communicated with the emissions analyzer 22 at the output end 28 of the tube 24.

In view of the above, it will be seen that the several objects and advantages of the present invention have been achieved and other advantageous results have been obtained.

As various changes could be made in the above constructions without departing from the scope of the invention, it is intended that all matter contained in the above description or shown in the accompanying drawings shall be interpreted as illustrative and not in a limiting sense.

1. An impedance heated continuous emission monitoring system comprising:
an emissions analyzer;
a tube, the tube having a length between an input end of the tube and an opposite output end of the tube;
the input end of the tube being configured for communication with a source of emissions;
the output end of the tube being configured for communication with the emissions analyzer;
a source of electric power;
a first cable, the first cable being connected between the source of electric power and the tube; and,
a second cable, the second cable being connected between the source of electric power and the tube.

2. The impedance heated continuous emission monitoring system of claim 1, further comprising:
the emissions analyzer being a gas analyzer.

3. The impedance heated continuous emission monitoring system of claim 1, further comprising:
the tube being one tube of a multiple of tubes bundled together.

4. The impedance heated continuous emission monitoring system of claim 1, further comprising:
the source of electric power being a transformer.

5. The impedance heated continuous emission monitoring system of claim 1, further comprising:
the first cable being connected to one of the input end of the tube and the output end of the tube; and,
the second cable being connected to the output end of the tube when the first cable is connected to the input end of the tube, and the second cable being connected to the input end of the tube when the first cable is connected to the output end of the tube.

6. An emissions monitoring system comprising:
an emissions analyzer;
a tubing system, the tubing system being configured for communicating with the emissions analyzer and with emissions; and
a source of electric power delivering electric power to the tubing system and creating impedance heating of the tubing system that heats emissions passing through the tubing system to the emissions analyzer and keeps a temperature of the emissions above a dew point temperature of the emissions.

7. The emissions monitoring system of claim 6, further comprising:
a stack, the stack containing the emissions; and
the tubing system is configured for communicating with the stack.

8. The emissions monitoring system of claim 6, further comprising:
the tubing system is constructed of a metallic material that is a heat conductor.

9. The emissions monitoring system of claim 8, further comprising:
the tubing system is constructed of stainless steel.

10. The emissions monitoring system of claim 6, further comprising:
the tubing system is a tube that has an unobstructed interior bore that extends through the tube.

11. The emissions monitoring system of claim 6, further comprising:
the tubing system is a single tube.

12. The emissions monitoring system of claim 6, further comprising:
the tubing system is a plurality of tubes arranged in a bundle.

13. The emissions monitoring system of claim 6, further comprising:
the tubing system is a tube, the tube has an input end and an opposite output end, the input end of the tube is configured for communicating with a stack containing the emissions and the output end of the tube is configured for communicating with the emissions analyzer.

14. An emissions monitoring system comprising:
an emissions analyzer;
a tubing system, the tubing system having an input end and an opposite output end;
the output end of the tubing system is configured for communicating with the emissions analyzer;
the input end of the tubing system is configured for communicating with emissions; and
a source of electric power delivering electric power to the tubing system and producing an electric current flow through the tubing system, the electric current flow through the tubing system creating impedance heating of the tubing system that heats emissions passing through the tubing system keeping the emissions above a dew point temperature of the emissions.

15. The emissions monitoring system of claim 14, further comprising:
the tubing system is constructed of a metallic material that is a heat conductor.

16. The emissions monitoring system of claim 15, further comprising:
the tubing system is constructed of stainless steel.

17. The emissions monitoring system of claim 14, further comprising:
the tubing system is a tube that has an unobstructed interior bore that extends through the tube.

18. The emissions monitoring system of claim 14, further comprising:
the tubing system is a single tube.

19. The emissions monitoring system of claim 14, further comprising:
the tubing system is a plurality of tubes arranged in a bundle.

20. The emissions monitoring system of claim 14, further comprising:
the tubing system is a tube, the tube has an input end and an opposite output end, the input end of the tube is configured for communicating with a stack containing the emissions and the output end of the tube is configured for communicating with the emissions analyzer.
